(19) United States
(12) Patent Application Publication
(10) Pub. No.: US 2025/0225379 A1
(43) Pub. Date: Jul. 10, 2025

(54) MACHINE LEARNING BASED ON HIERARCHICAL DECOMPOSITION OF TIME SERIES DATA

(71) Applicant: ADOBE INC., SAN JOSE, CA (US)

(72) Inventors: Wei Zhang, Great Falls, VA (US); Tao Sun, Stony Brook, NY (US)

(21) Appl. No.: 18/404,378

(22) Filed: Jan. 4, 2024

(51) Int. Cl. G06N 3/0499; G06N 3/084

(52) U.S. Cl. CPC G06N 3/0499; G06N 3/084

(57) ABSTRACT

Methods, non-transitory computer readable media, apparatuses, and systems for training a machine learning model include creating, using the machine learning model, a first training set by applying a first window size to a time series and a second training set by applying a second window size to the time series, where the second window size is less than the first window size. A training component trains a first layer of the machine learning model using the first training set and a second layer of the machine learning model using the second training set.

### BACKGROUND

The following relates generally to machine learning, and more specifically to machine learning for time series forecasting. Time series are ubiquitous in daily life. Time series forecasting aims to predict a value of future time steps given historic observations. It is a long-standing task with a wide range of applications.

Long-term Time Series Forecasting (LTSF) is a particular task that includes predicting a future time window in the long-term. LTSF is challenging because, in some cases, a correlation between a long-term future and historical data is hard to unveil. Also, in some cases, a data distribution in a time series shifts as time progresses, which renders an assumption of independent and identically distributed random variables in the time series invalid, and which therefore hinders an ability of machine learning models to make predictions based on the time series. There is therefore a need in the art for a machine learning model that provides an accurate prediction based on a time series.

### SUMMARY

Embodiments of the present disclosure provide a machine learning model for predicting making predictions based on a hierarchical decomposition of time series data. According to some aspects, a machine learning model creates a first training set by applying a first window size to a time series, and first layer of the machine learning model is trained using the first training set. According to some aspects, the machine learning model creates a second training set by applying a second window size to the time series, and a second layer of the machine learning model is trained using the second training set. In some cases, the second window size is less than the first window size.

Accordingly, in some cases, by respectively training successive layers of the machine learning model based on created training sets of successively decreasing granularity (e.g., of a successively increasing number of samples within the training sets), the machine learning model learns from a time series in a hierarchical manner, and is therefore able to provide an accurate prediction based on the time series that is more robust against a potential shift in data distribution in the time series than conventional time series forecasting systems and techniques.

A method, apparatus, non-transitory computer readable medium, and system for training a machine learning model are described. One or more aspects of the method, apparatus, non-transitory computer readable medium, and system include creating, using a machine learning model, a first training set by applying a first window size to a time series; training, using a training component, a first layer of the machine learning model using the first training set; creating, using the machine learning model, a second training set by applying a second window size to the time series, wherein the second window size is less than the first window size; and training, using the training component, a second layer of the machine learning model using the second training set.

A method, apparatus, non-transitory computer readable medium, and system for providing digital content are described. One or more aspects of the method, apparatus, non-transitory computer readable medium, and system include obtaining, using a machine learning model, user interaction data; decomposing, using the machine learning model, the user interaction data into a first set of steps based on a first window size and a second set of steps based on a second window size, wherein the second window size is less than the first window size; generating, using the machine learning model, predicted user interaction data based on the user interaction data by generating a first intermediate output using a first layer of the machine learning model based on the first set of steps and generating a second intermediate output using a second layer of the machine learning model based on the second set of steps and the first intermediate output; and providing, via a user interface, digital content to a user based on the predicted user interaction data.

An apparatus and system for time series data prediction are described. One or more aspects of the apparatus and system include at least one processor; at least one memory storing instructions executable by the at least one processor; and a machine learning model comprising machine learning parameters stored in the at least one memory, the machine learning model trained to predict time series data, the machine learning model comprising a first layer trained using a first training set created by applying a first window size to a time series and a second layer trained using a second training set created by applying a second window size to the time series, wherein the second window size is less than the first window size.

### BRIEF DESCRIPTION OF THE DRAWINGS

FIG. 1 shows an example of a data processing system according to aspects of the present disclosure.

FIG. 2 shows an example of a data processing apparatus according to aspects of the present disclosure.

FIG. 3 shows an example of data flow in a data processing apparatus according to aspects of the present disclosure.

FIG. 4 shows an example of providing digital content based on predicted user interaction data according to aspects of the present disclosure.

FIG. 5 shows an example of a method for providing digital content according to aspects of the present disclosure.

FIG. 6 shows an example of hierarchical decomposition of a time series according to aspects of the present disclosure.

FIG. 7 shows an example of hierarchical prediction of time series data according to aspects of the present disclosure.

FIG. 8 shows an example of a method for training a machine learning model according to aspects of the present disclosure.

FIG. 9 shows an example of mini-batch sampling according to aspects of the present disclosure.

FIG. 10 shows an example of applying continuity regularization and moving average techniques according to aspects of the present disclosure.

### DETAILED DESCRIPTION

Time series are ubiquitous in daily life. Time series forecasting aims to predict a value of future time steps given historic observations. It is a long-standing task with a wide range of applications. Long-term Time Series Forecasting (LTSF), a core task in many time series analyses, includes predicting a future time window in the long-term. In some cases, LTSF is challenging because a correlation between a long-term future and historical data is hard to unveil.

Some conventional time-indexed models for LTSF heavily rely on a presumption of Fourier periodicity in data. For example, the conventional time-indexed models map each time of a time series to a corresponding value using a fitted function y(t)=T(t)+S(t)+E(t), where the trend term T(t) is modeled as a piece-wise linear function, the seasonality term S(t) is modeled as a Fourier series with daily/weekly/yearly periodicity, and occasional event term E(t) is modeled as discrete Dirac delta functions. Conventional time-indexed models are simple to use, but have several drawbacks, as presumptions on the linear and Fourier forms are specifically tailored to business data, with less generalizability to diverse data distribution, and it is difficult to update parameters of a time-indexed model that has been fitted on existing data when new data becomes available.

Alternatively, auto-regression models are conventionally used to perform LTSF. In some cases, conventional auto-regression models map a context C right before a prediction time step to a future window, formulated as Y=f(C), where in addition to historic observations, information from other sources such as relevant time series are optionally incorporated into the context C, and f is formulated to best capture temporal and spatial correlation among time series data. Auto-regression models are useful for multi-variate predictions, and stochastic gradient descent training allows auto-regression models to easily adapt to new data.

Some conventional auto-regression models include transformer-based architectures. However, transformers are architecturally sophisticated and expensive, and in some cases are outperformed by linear models. Linear auto-regression models (e.g., models based on feedforward networks) have an advantage over transformer-based architectures by being lighter, faster, and more robust to hyper-parameters.

A conventional linear model decomposes a time series into a trend component from a moving average and a seasonality component from the residual of the time series, and makes a prediction based on a sum of predictions for the trend component and the seasonality component. However, the conventional linear model does not always provide accurate predictions, especially when working from time series data that demonstrate distribution shifts in the general trend, which prevent the conventional linear auto-regression model from capturing the distribution shifts in a near window.

Embodiments of the present disclosure provide a machine learning model for predicting making predictions based on a hierarchical decomposition of time series data. According to some aspects, a data processing apparatus includes at least one processor, at least one memory storing instructions executable by the at least one processor, and a machine learning model comprising machine learning parameters stored in the at least one memory. In some cases, the machine learning model is trained to predict time series data. In some cases, the machine learning model includes a first layer trained using a first training set created by applying a first window size to a time series and a second layer trained using a second training set created by applying a second window size to the time series. In some cases, the second window size is less than the first window size.

Accordingly, in some cases, by respectively training successive layers of the machine learning model based on created training sets of successively decreasing granularity (e.g., of a successively increasing number of samples within the training sets), the machine learning model learns from a time series in a hierarchical manner, and is therefore able to provide an accurate prediction based on the time series that is not affected by a potential shift in data distribution in the time series.

As used herein, a “time series” refers to set of data points in numerical order over successive temporal intervals. As used herein, a “window” refers to a subset of a time series. As used herein, in some cases, a “window size” corresponds to an amount of data points in a window, where a number of data points in a window is equal to a number of data points in a time series divided by the window size. As used herein, a “line parameter” refers to a parameter that represents a line corresponding to a set of data points, such as an average, a slope, etc.

An embodiment of the present disclosure is used in a content distribution context. For example, a machine learning model of a data processing system according to an embodiment of the present disclosure receives a set of user interaction data. The set of user interaction data is a time series, recording a user's engagement with a website over a period of time (such as a year). The machine learning model decomposes the user interaction data into a first set of steps based on a first window size and a second set of steps based on a second window size, where the second window size is less than the first window size.

The machine learning model then generates predicted user interaction data for the user based on the user interaction data in a hierarchical manner. For example, a first layer of the machine learning model generates a first intermediate output based on the first set of steps, and a second layer of the machine learning model generates a second intermediate output based on the second set of steps and the first intermediate output, where the predicted user interaction data is a sum of the first intermediate output and the second intermediate output.

A user interface of the data processing system provides digital content to the user based on the predicted user interaction data. For example, the predicted user interaction data indicates that the user is likely to buy a product from the website in the next month. A digital content component of the data processing system generates a message for the user based on information about the user, the website, the product, and the likelihood of the user to purchase the product in the next month. The user interface displays the digital content to the user on the website.

Accordingly, by generating the predicted user interaction data in a hierarchical manner using multiple layers of the machine learning model based on a hierarchical decomposition of the user interaction data into windows of multiple sizes, an accuracy of the predicted user interaction data is increased, and digital content that is uniquely tailored for the user and the user's predicted circumstance is therefore allowed to be provided, thereby increasing an effectiveness and efficiency of digitally provided content over conventional systems and techniques.

As used herein, “user interaction data” refers to a time series relating to a user's historical interactions with a digital content channel. As used herein, a “digital content channel” refers to a channel (such as a website, a software application, an Internet-based application, an email service, a messaging service such as SMS, instant messaging, etc., a television service, a telephone service, etc.) through which digital content is provided. As used herein, “digital content” refers to media such as text, audio, images, video, or a combination thereof.

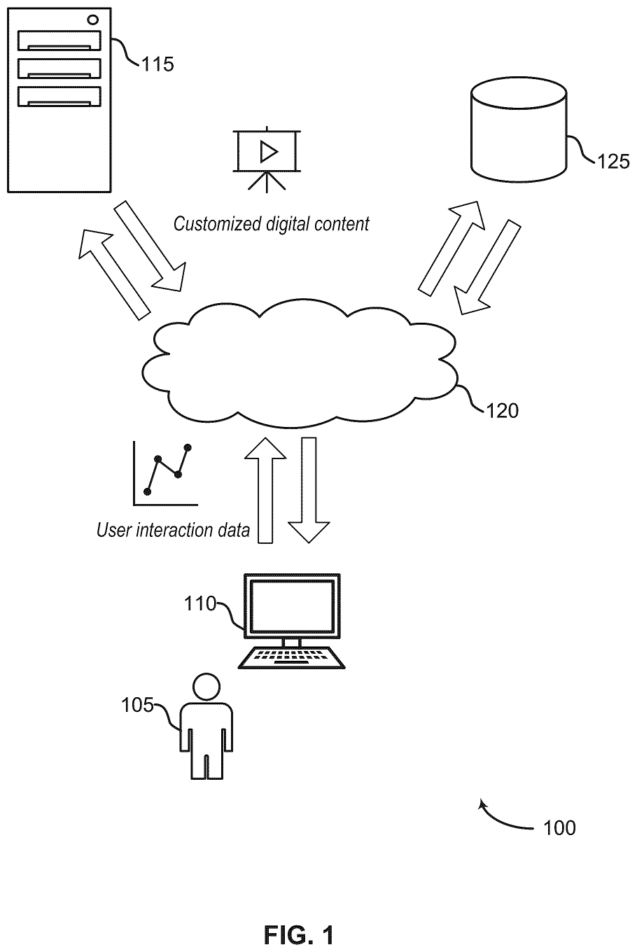

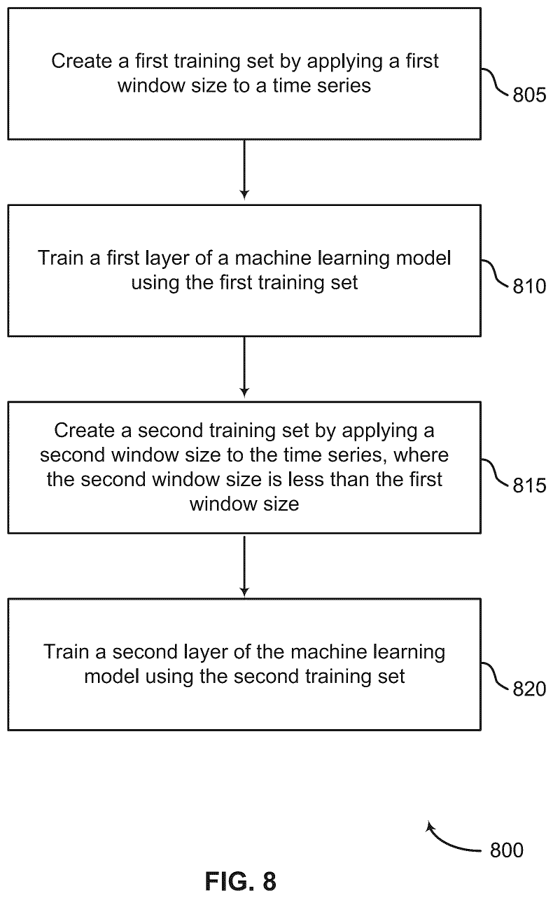

Further example applications of the present disclosure in the content distribution context are provided with reference to FIGS. 1 and 4-7. Details regarding the architecture of the data processing system are provided with reference to FIGS. 1-3. Examples of a process for training a machine learning model are provided with reference to FIGS. 8-10.

### Data Processing System

A system and an apparatus for time series data prediction is described with reference to FIGS. 1-3. One or more aspects of the system and the apparatus include at least one processor; at least one memory storing instructions executable by the at least one processor; and a machine learning model comprising machine learning parameters stored in the at least one memory, the machine learning model trained to predict time series data, the machine learning model comprising a first layer trained using a first training set created by applying a first window size to a time series and a second layer trained using a second training set created by applying a second window size to the time series, wherein the second window size is less than the first window size. Some examples of the apparatus and system further include a user interface configured to provide content to a user based on an output of the machine learning model.

In some aspects, the machine learning model further comprises a third layer trained using a third training set created by applying a third window size to the time series, wherein the third window size is less than the second window size. In some aspects, the machine learning model further comprises a residual layer trained based on an output of the first layer, an output of the second layer, and the time series.

FIG. 1 shows an example of a data processing system 100 according to aspects of the present disclosure. The example shown includes data processing system 100, user 105, user device 110, data processing apparatus 115, cloud 120, and database 125.

Referring to FIG. 1, data processing apparatus 115 receives user interaction data from user device 110 of user 105. In some cases, data processing apparatus 115 receives the user interaction data by monitoring a website that user 105 engages with. Data processing apparatus 115 determines predicted user interaction data based on the user interaction data, and provides customized digital content to user 105 based on the predicted user interaction data.

According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by data processing apparatus 115. In some aspects, the user interface allows information to be communicated between user 105 and data processing apparatus 115.

According to some aspects, a user device user interface enables user 105 to interact with user device 110. In some embodiments, the user device user interface includes an audio device, such as an external speaker system, an external display device such as a display screen, or an input device (e.g., a remote-control device interfaced with the user interface directly or through an I/O controller module). In some cases, the user device user interface is a graphical user interface.

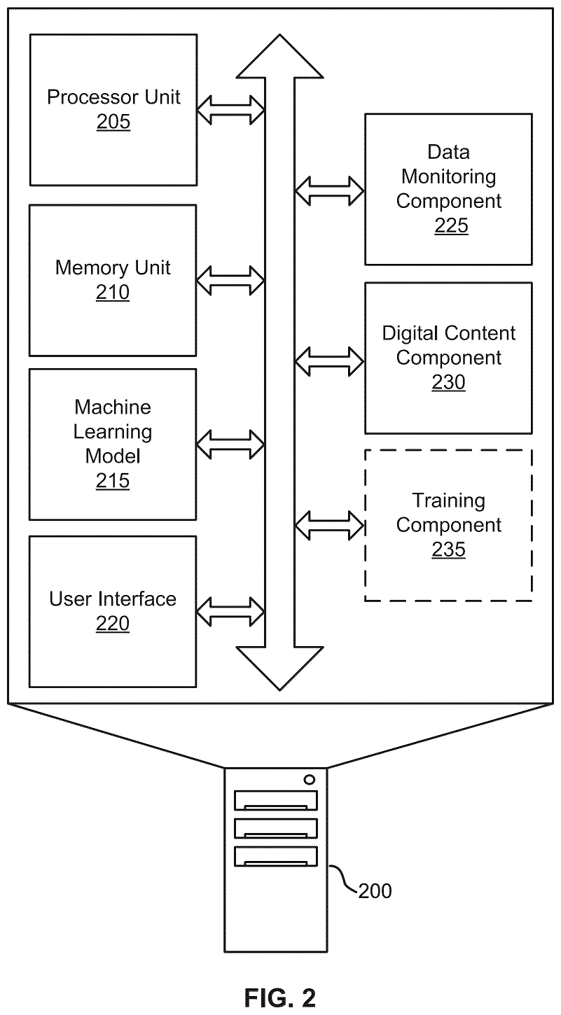

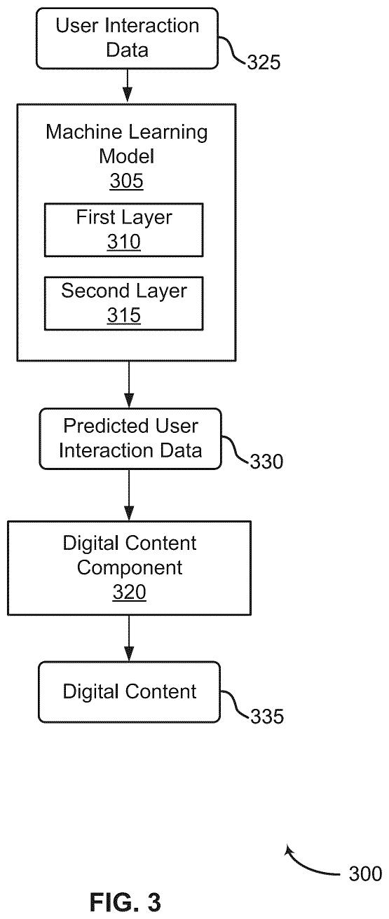

Data processing apparatus 115 is an example of, or includes aspects of, the corresponding element described with reference to FIGS. 2 and 3. According to some aspects, data processing apparatus 115 includes a computer-implemented network. In some embodiments, the computer-implemented network includes a machine learning model. In some embodiments, data processing apparatus 115 also includes one or more processors, a memory subsystem, a communication interface, an I/O interface, one or more user interface components, and a bus. Additionally, in some embodiments, data processing apparatus 115 communicates with user device 110 and database 125 via cloud 120.

In some cases, data processing apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via one or more protocols, such as hypertext transfer protocol (HTTP), simple mail transfer protocol (SMTP), file transfer protocol (FTP), simple network management protocol (SNMP), and the like. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

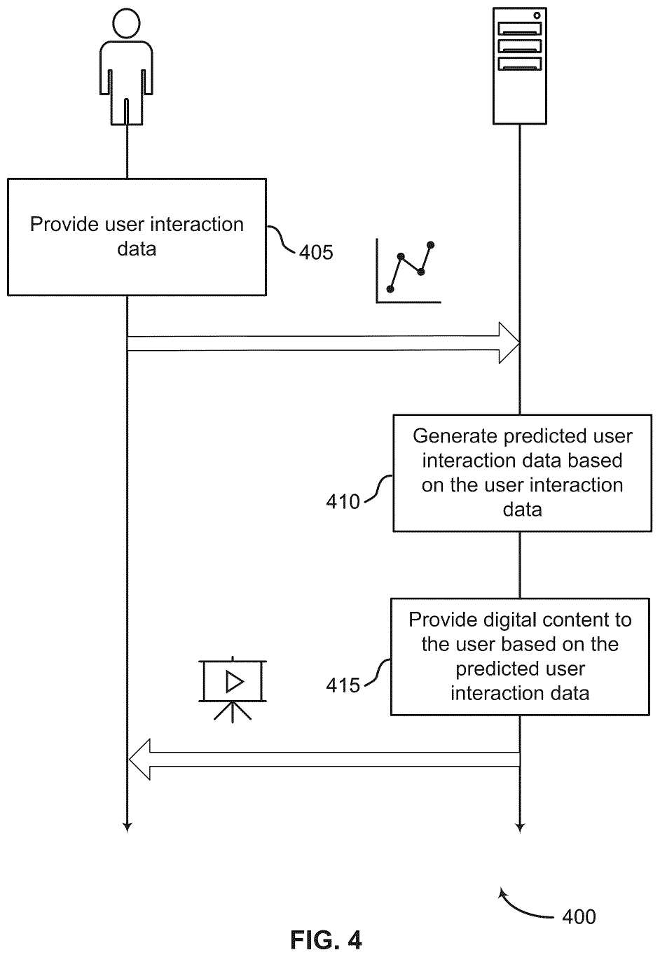

Further detail regarding the architecture of data processing apparatus 115 is provided with reference to FIGS. 2-3. Further detail regarding a process for providing digital content is provided with reference to FIGS. 4-7. Examples of a process for training a machine learning model are provided with reference to 8-10.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet.

Some large cloud networks have functions distributed over multiple locations from central servers. A server is designated an edge server if it has a direct or close connection to a user. In some cases, cloud 120 is limited to a single organization. In other examples, cloud 120 is available to many organizations.

In one example, cloud 120 includes a multi-layer communications network comprising multiple edge routers and core routers. In another example, cloud 120 is based on a local collection of switches in a single physical location. According to some aspects, cloud 120 provides communications between user device 110, data processing apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to data processing apparatus 115 and communicates with data processing apparatus 115 via cloud 120. According to some aspects, database 125 is included in data processing apparatus 115.

FIG. 2 shows an example of a data processing apparatus 200 according to aspects of the present disclosure. Data processing apparatus 200 is an example of, or includes aspects of, the corresponding element described with reference to FIGS. 1 and 3. In one aspect, data processing apparatus 200 includes processor unit 205, memory unit 210, machine learning model 215, user interface 220, data monitoring component 225, digital content component 230, and training component 235.

Processor unit 205 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 205 is configured to operate a memory array using a memory controller. In other cases, a memory controller is integrated into processor unit 205. In some cases, processor unit 205 is configured to execute computer-readable instructions stored in memory unit 210 to perform various functions. In some aspects, processor unit 205 includes special purpose components for modem processing, baseband processing, digital signal processing, or transmission processing.

Memory unit 210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 205 to perform various functions described herein.

In some cases, memory unit 210 includes a basic input/output system (BIOS) that controls basic hardware or software operations, such as an interaction with peripheral components or devices. In some cases, memory unit 210 includes a memory controller that operates memory cells of memory unit 210. For example, in some cases, the memory controller includes a row decoder, column decoder, or both. In some cases, memory cells within memory unit 210 store information in the form of a logical state.

Machine learning model 215 is an example of, or includes aspects of, the corresponding element described with reference to FIG. 3. According to some aspects, machine learning model 215 is implemented as software stored in memory unit 210 and executable by processor unit 205, as firmware, as one or more hardware circuits, or as a combination thereof.

According to some aspects, machine learning model 215 comprises machine learning parameters stored in memory unit 210. Machine learning parameters, also known as model parameters or weights, are variables that provide a behavior and characteristics of a machine learning model. In some cases, machine learning parameters are learned or estimated from training data and are used to make predictions or perform tasks based on learned patterns and relationships in the data.

Machine learning parameters are typically adjusted during a training process to minimize a loss function or maximize a performance metric. The goal of the training process is to find optimal values for the parameters that allow the machine learning model to make accurate predictions or perform well on the given task. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

Artificial neural networks (ANNs) have numerous parameters, including weights and biases associated with each neuron in the network, that control a degree of connections between neurons and influence the neural network's ability to capture complex patterns in data. An ANN is a hardware component or a software component that includes a number of connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

In some cases, the signals between nodes comprise real numbers, and the output of each node is computed by a function of the sum of its inputs. In some examples, nodes determine their output using other mathematical algorithms, such as selecting the max from the inputs as the output, or any other suitable algorithm for activating the node. Each node and edge are associated with one or more node weights that determine how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

During a training process of an ANN, the node weights are adjusted to improve the accuracy of the result (i.e., by minimizing a loss which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

According to some aspects, machine learning model 215 comprises one or more ANNs trained to predict time series data. In some cases, the one or more ANNs comprise one or more feedforward networks. In a feedforward neural network (also known as a multilayer perceptron (MLP)), information flows in a unidirectional manner, from the input layer to the output layer, without forming cycles. In some cases, a feedforward network comprises an input layer that receives initial data, one or more hidden layers that enable the learning of complex representations, and an output layer that produces an output.

In some cases, connections between nodes in different layers of the feedforward network have associated weights, and nodes in hidden layers apply activation functions to introduce non-linearities. In some cases, during training, the feedforward network adjusts weights and biases using supervised learning, optimizing its predictions based on the error between predicted and actual values.

In some cases, machine learning model 215 comprises a first layer trained using a first training set created by applying a first window size to a time series and a second layer trained using a second training set created by applying a second window size to the time series, where the second window size is less than the first window size. In some aspects, the machine learning model 215 further includes a third layer trained using a third training set created by applying a third window size to the time series, where the third window size is less than the second window size. In some aspects, the machine learning model 215 further includes a residual layer trained based on an output of the first layer, an output of the second layer, and the time series.

According to some aspects, machine learning model 215 creates a first training set by applying a first window size to a time series. In some examples, machine learning model 215 creates a second training set by applying a second window size to the time series, where the second window size is less than the first window size.

In some examples, machine learning model 215 divides the time series into a set of first steps having the first window size, where the first layer of the machine learning model 215 is trained to predict one or more line parameters for each of the set of first steps. In some examples, machine learning model 215 divides the time series into a set of second steps having the second window size, where the second layer of machine learning model 215 is trained to predict the one or more line parameters for each of the set of second steps.

In some aspects, machine learning model 215 computes a first line parameter for a first portion of the time series corresponding to the first window size. In some examples, machine learning model 215 computes, using a first layer of machine learning model 215, a first predicted line parameter for the first portion of the time series. In some examples, machine learning model 215 computes a second line parameter for a second portion of the time series corresponding to the second window size.

In some examples, machine learning model 215 computes, using the second layer of machine learning model 215, a second predicted line parameter for the second portion of the time series. In some aspects, the first line parameter includes a scalar value or a slope value. In some examples, machine learning model 215 creates a third training set by applying a third window size to the time series, where the third window size is less than the second window size.

According to some aspects, machine learning model 215 obtains user interaction data. In some examples, machine learning model 215 decomposes the user interaction data into a first set of steps based on a first window size and a second set of steps based on a second window size, where the second window size is less than the first window size. In some examples, machine learning model 215 generates predicted user interaction data based on the user interaction data by generating a first intermediate output using a first layer of the machine learning model 215 based on the first set of steps and generating a second intermediate output using a second layer of the machine learning model 215 based on the second set of steps and the first intermediate output.

In some aspects, generating the predicted user interaction data includes generating a third intermediate output using a third layer of machine learning model 215 based on a third set of steps, the first intermediate output, and the second intermediate output, where the third set of steps is based on a third window size. In some aspects, generating the predicted user interaction data includes generating a residual output using a residual layer of the machine learning model 215 based on the user interaction data, the first intermediate output, and the second intermediate output.

In some aspects, the first intermediate output and the second intermediate output include line parameters for linearized portions of the user interaction data. In some aspects, machine learning model 215 is trained based on a hierarchical decomposition of a training time series.

According to some aspects, user interface 220 is implemented as software stored in memory unit 210 and executable by processor unit 205, as firmware, as one or more hardware circuits, or as a combination thereof. According to some aspects, user interface 220 includes a graphical user interface. According to some aspects, user interface 220 provides digital content to a user based on the predicted user interaction data. In some examples, user interface 220 displays the digital content on a website. According to some aspects, user interface 220 is configured to provide content to a user based on an output of machine learning model 215.

According to some aspects, data monitoring component 225 is implemented as software stored in memory unit 210 and executable by processor unit 205, as firmware, as one or more hardware circuits, or as a combination thereof. According to some aspects, data monitoring component 225 monitors user engagement with a website.

Digital content component 230 is an example of, or includes aspects of, the corresponding element described with reference to FIG. 3. According to some aspects, digital content component 230 is implemented as software stored in memory unit 210 and executable by processor unit 205, as firmware, as one or more hardware circuits, or as a combination thereof. In some aspects, digital content component 230 generates the digital content based on the predicted user interaction data. In some aspects, digital content component 230 retrieves the digital content from a database (such as the database described with reference to FIG. 1) based on the predicted user interaction data.

In some cases, digital content component 230 comprises one or more algorithms (such as a procedural generation algorithm, a template-based algorithm, etc.) configured to generate the digital content based on the predicted user interaction data. According to some aspects, digital content component 230 comprises one or more ANNs configured to generate the digital content based on the predicted user interaction data. For example, in some cases, digital content component 230 comprises one or more of a generative language model (such as transformer-based generative language model) configured to generate text, an image generation model (such as a diffusion model, a generative adversarial network, and the like) configured to generate an image, a video generation model configured to generate a video, and an audio generation model configured to generate audio.

According to some aspects, training component 235 is implemented as software stored in memory unit 210 and executable by processor unit 205, as firmware, as one or more hardware circuits, or as a combination thereof. According to some aspects, training component 235 is omitted from data processing apparatus 200. According to some aspects, training component 235 is implemented as software stored in a memory unit of an external apparatus and executable by a processor unit of the external apparatus, as firmware, as one or more hardware circuits, or as a combination thereof in the external apparatus, and communicates with data processing apparatus 200 to perform the training component functions described herein.

According to some aspects, training component 235 trains a first layer of machine learning model 215 using the first training set. In some examples, training component 235 trains a second layer of machine learning model 215 using the second training set. In some examples, training component 235 computes a first loss function based on the first line parameter and the first predicted line parameter. In some examples, training component 235 computes a second loss function based on the second line parameter, the second predicted line parameter, and the first predicted line parameter.

In some examples, training component 235 trains a third layer of machine learning model 215 using the third training set. In some examples, training component 235 trains a residual layer of machine learning model 215 based on an output of the first layer, an output of the second layer, and the time series. In some aspects, the second layer is trained based on an output of the first layer.

FIG. 3 shows an example of data flow in a data processing apparatus 300 according to aspects of the present disclosure. The example shown includes data processing apparatus 300, user interaction data 325, predicted user interaction data 330, and digital content 335.

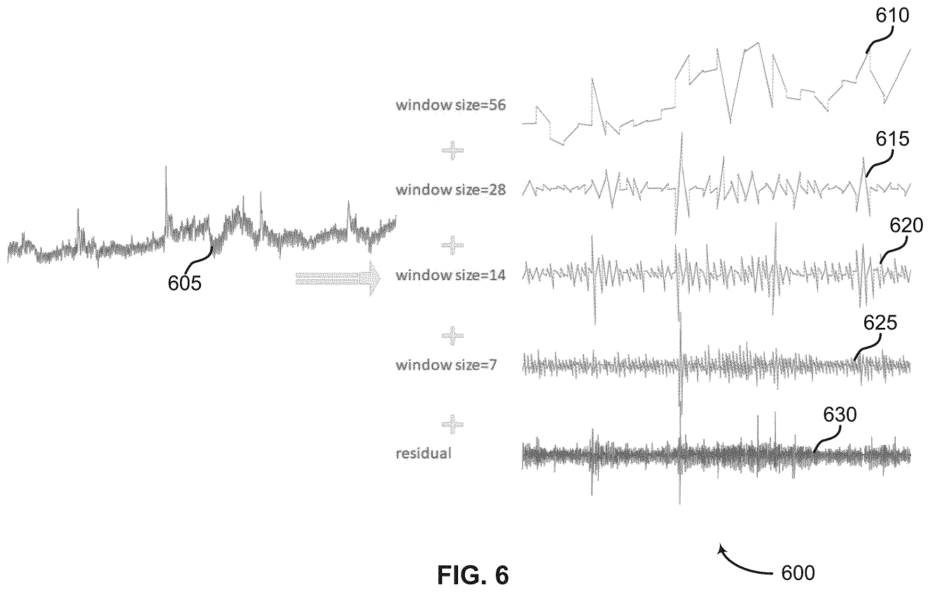

Data processing apparatus 300 is an example of, or includes aspects of, the corresponding element described with reference to FIGS. 1 and 2. In one aspect, data processing apparatus 300 includes machine learning model 305 and digital content component 320. Machine learning model 305 is an example of, or includes aspects of, the corresponding element described with reference to FIG. 2. In one aspect, machine learning model 305 includes first layer 310 and second layer 315. Digital content component 320 is an example of, or includes aspects of, the corresponding element described with reference to FIG. 2. User interaction data 325 is an example of, or includes aspects of, the corresponding element described with reference to FIG. 6.

In the example of FIG. 3, machine learning model 305 receives user interaction data 325. Machine learning model 305 decomposes user interaction data 325 into a first set of steps and a second set of steps having a smaller window size than the first set of steps, generates a first intermediate output based on the first set of steps using first layer 310, and generates a second intermediate output based on the second set of steps using second layer 315.

Machine learning model 305 sums the first intermediate output and the second intermediate output to obtain predicted user interaction data 330. Digital content component 320 receives predicted user interaction data 330 and generates digital content 335 based on predicted user interaction data 330.

### Providing Digital Content

A method for providing digital content is described with reference to FIGS. 4-7. One or more aspects of the method include obtaining user interaction data; decomposing the user interaction data into a first set of steps based on a first window size and a second set of steps based on a second window size, wherein the second window size is less than the first window size; generating predicted user interaction data based on the user interaction data by generating a first intermediate output using a first layer of the machine learning model based on the first set of steps and generating a second intermediate output using a second layer of the machine learning model based on the second set of steps and the first intermediate output; and providing digital content to a user based on the predicted user interaction data.

In some aspects, obtaining the user interaction data comprises monitoring user engagement with a website. In some aspects, providing digital content comprises generating the digital content based on the predicted user interaction data. Some examples further include displaying the digital content on a website.

In some aspects, generating the predicted user interaction data comprises generating a third intermediate output using a third layer of the machine learning model based on a third set of steps, the first intermediate output, and the second intermediate output, wherein the third set of steps is based on a third window size.

In some aspects, generating the predicted user interaction data comprises generating a residual output using a residual layer of the machine learning model based on the user interaction data, the first intermediate output, and the second intermediate output. In some aspects, the first intermediate output and the second intermediate output comprise line parameters for linearized portions of the user interaction data. In some aspects, the machine learning model is trained based on a hierarchical decomposition of a training time series.

FIG. 4 shows an example of a method 400 for providing digital content according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

In the example of FIG. 4, a data processing apparatus of the data processing system (such as the data processing apparatus described with reference to FIG. 1) receives user interaction data from a user (such as the user described with reference to FIG. 1). In some cases, the data processing apparatus receives the user interaction data by monitoring a website that the user engages with. The data processing apparatus determines predicted user interaction data based on the user interaction data, and provides customized digital content to the user based on the predicted user interaction data.

At operation 405, a user provides user interaction data. In some cases, the operations of this step refer to, or are performed by, a user as described with reference to FIG. 1. In some cases, the data processing apparatus receives the user interaction data via monitoring a website or other digital content channel that the user interacts with.

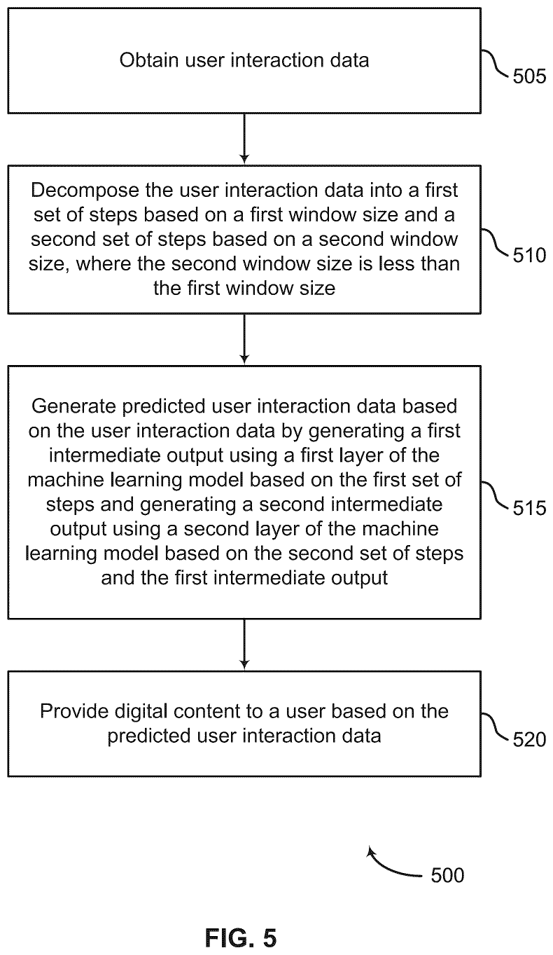

At operation 410, the system generates predicted user interaction data based on the user interaction data. In some cases, the operations of this step refer to, or are performed by, a data processing apparatus as described with reference to FIGS. 1-3. For example, in some cases, a machine learning model of the data processing apparatus (such as the machine learning model described with reference to FIGS. 2-3) decomposes the user interaction data in a hierarchical manner into increasingly fine windows, and uses layers of the machine learning model to generate the predicted user interaction data for a future time period, where each layer corresponds to one window, and where each successive layer after the first layer takes as input an increasingly fine window and generates its output based on an output of a previous layer, and sums the outputs of the layers to obtain the predicted user interaction data, as described with reference to FIG. 5.

At operation 415, the system provides digital content to the user based on the predicted user interaction data. In some cases, the operations of this step refer to, or are performed by, a data processing apparatus as described with reference to FIGS. 1-3. For example, in some cases, the data processing apparatus generates or retrieves digital content based on the predicted user interaction data and displays the predicted user interaction data to the user as described with reference to FIG. 5.

FIG. 5 shows an example of a method 500 for providing digital content according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 5, an embodiment of the present disclosure is used in a content distribution context. For example, a machine learning model (such as the machine learning model described with reference to FIGS. 2-3, and trained as described with reference to FIGS. 8-10) receives a set of user interaction data. In some cases, for example, the set of user interaction data is a time series, recording a user's engagement with a website over a period of time (such as a year). In some cases, the machine learning model decomposes the user interaction data into a first set of steps based on a first window size and a second set of steps based on a second window size, where the second window size is less than the first window size.

In some cases, the machine learning model then generates predicted user interaction data for the user based on the user interaction data in a hierarchical manner. For example, in some cases, a first layer of the machine learning model generates a first intermediate output based on the first set of steps, and a second layer of the machine learning model generates a second intermediate output based on the second set of steps and the first intermediate output, where the predicted user interaction data is a sum of the first intermediate output and the second intermediate output.

In some cases, a user interface of the data processing system provides digital content to the user based on the predicted user interaction data. For example, in some cases, the predicted user interaction data indicates that the user is likely to buy a product from the website in the next month. In some cases, a digital content component of the data processing system generates digital content for the user (such as a website pop-up message) based on the predicted user interaction data. In some cases, the user interface displays the digital content to the user on the website.

Accordingly, by generating the predicted user interaction data in a hierarchical manner using multiple layers of the machine learning model based on a hierarchical decomposition of the user interaction data into windows of multiple sizes, an accuracy of the predicted user interaction data is increased, and digital content that is uniquely tailored for the user and the user's predicted circumstance is therefore allowed to be provided, thereby increasing an effectiveness and efficiency of digitally provided content over conventional systems and techniques.

At operation 505, the system obtains user interaction data. In some cases, the operations of this step refer to, or are performed by, a machine learning model as described with reference to FIGS. 2 and 3.

In some cases, the user interaction data comprises a time series of data. In some cases, the user interaction data is data relating to an interaction of a user with one or more websites. In some cases, the user interaction data is set of interactions, where each interaction is associated with a timestamp. Examples of interaction data include records of visits to the one or more websites, time spent on the one or more websites, mouse movement while on the one or more websites, websites visited before and after visiting the one or more websites, hyperlinks clicked while on the one or more websites, items added to a shopping cart while on the one or more websites, items purchased from the one or more websites, or the like. In some cases, a data monitoring component (such as the data monitoring component described with reference to FIG. 2) obtains the user interaction data by monitoring user engagement with the one or more websites (for example, via API calls or the like), and recording the user engagement. In some cases, the data monitoring component provides the user interaction data to the machine learning model.

At operation 510, the system decomposes the user interaction data into a first set of steps based on a first window size and a second set of steps based on a second window size, where the second window size is less than the first window size. In some cases, the operations of this step refer to, or are performed by, a machine learning model as described with reference to FIGS. 2 and 3. In some cases, one or more of the first window size and the second window size is predefined. In some cases, one or more of the first window size and the second window size is predefined based on a periodicity of the user interaction data. In some cases, given a time series X=[x₀, x₁, . . . , x_{T-1}] of T steps, a window τ=T/L, where the time series X is split into L segments [X₀, X₁, . . . , X_{L-1}], and where Xᵢ=[x_{i+τ}, x_{i+τ+1}, . . . , x_{(i+1)*τ-1}]. An example of a hierarchical decomposition of user interaction data is described with reference to FIG. 6.

At operation 515, the system generates predicted user interaction data based on the user interaction data by generating a first intermediate output using a first layer of the machine learning model based on the first set of steps and generating a second intermediate output using a second layer of the machine learning model based on the second set of steps and the first intermediate output. In some cases, the operations of this step refer to, or are performed by, a machine learning model as described with reference to FIGS. 2 and 3.

According to some aspects, the first intermediate output and the second intermediate output comprise line parameters for linearized portions of the user interaction data. For example, in some cases, each linear segment of the user interaction data is represented by one or more line parameters including a scalar value (such as a mean value m) and a slope d. In some cases, instead of predicting a value of every time step, the machine learning model predicts one or more line parameters (e.g., the first intermediate output and the second intermediate output) for the first set of steps and the second set of steps, respectively. In some cases, each layer of the machine learning model comprises a linear mapping Wₘ and W_{d}, where W is a matrix, to respectively predict {m, d} of a future time (e.g., the predicted user interaction data based on that of contexts). In some cases, the predicted user interaction data comprises a sum of the first intermediate output and the second intermediate output.

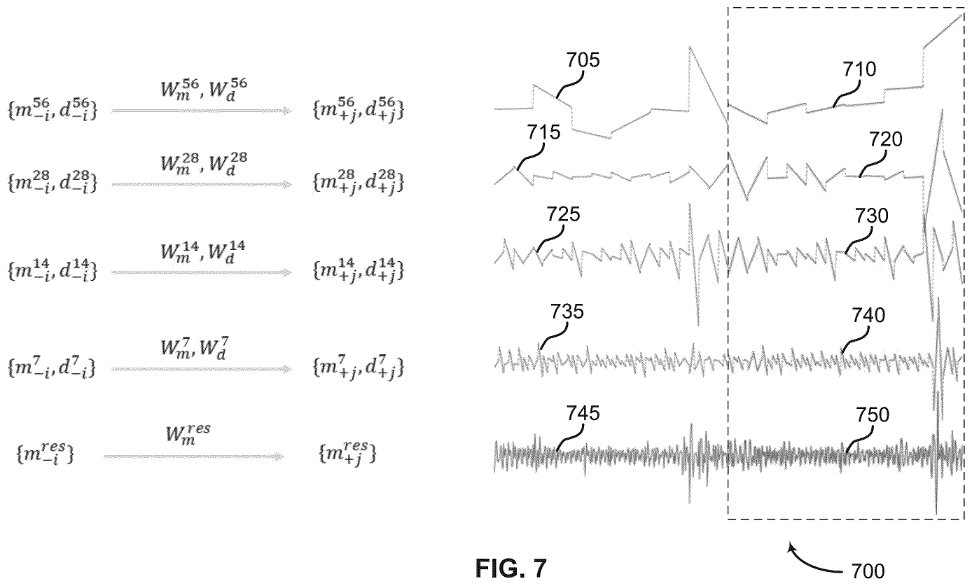

In some cases, each of the first intermediate output, the second intermediate output, and the predicted user interaction data comprises a prediction of user interaction data for a future time period. In some cases, a user selects the future time period. An example of hierarchical predictions is described with reference to FIG. 7.

According to some aspects, the machine learning model generates a third intermediate output using a third layer of the machine learning model based on a third set of steps, the first intermediate output, and the second intermediate output. In some cases, the third set of steps is based on a third window size. In some cases, the predicted user interaction data comprises a sum of the first intermediate output, the second intermediate output, and the third intermediate output.

According to some aspects, the machine learning model generates a residual output using a residual layer of the machine learning model based on the user interaction data, the first intermediate output, and the second intermediate output. In the context of time series modeling, a residual refers to the difference between the observed value of a variable at a particular time and the value predicted by a model at that same time. In other words, in some cases, the residual represents the part of the observed data that the model was not able to explain. In some cases, the residual output represents a seasonal component of the predicted user interaction data. In some cases, the predicted user interaction data comprises a sum of the first intermediate output, the second intermediate output, the third intermediate output, and the residual output. In some cases, the predicted user interaction data also comprises a sum of one or more additional similar intermediate outputs determined by a corresponding layer of the machine learning model in a similar manner to the previously described intermediate outputs.

According to some aspects, the machine learning model is trained based on a hierarchical decomposition of a training time series. For example, in some cases, the machine learning model is trained as described with reference to FIGS. 8-10.

At operation 520, the system provides digital content to a user based on the predicted user interaction data. In some cases, the operations of this step refer to, or are performed by, a user interface as described with reference to FIG. 2. For example, in some cases, a digital content component generates or retrieves the digital content based on the predicted user interaction data, and the user interface displays the digital content on a website.

In some cases, the digital content component generates or retrieves the digital content based on an association between one or more of the predicted user interaction data, user information for the user, a segment of users including the user, and a content prompt (such as a text prompt including a text description of the content, an image prompt depicting information associated with the content, etc.) stored in a database (such as the database described with reference to FIG. 1). In some cases, the digital content component generates the digital content using the content prompt as input. In some cases, the digital content component generates the digital content using a generative machine learning model. In some cases, the digital content component generates the digital content using a generative algorithm. In some cases, the user interface displays the content on the website by communicating with an external server.

FIG. 6 shows an example 600 of an illustration of hierarchical decomposition according to aspects of the present disclosure. The example shown includes user interaction data 605, first set of steps 610, second set of steps 615, third set of steps 620, fourth set of steps 625, and residual set of steps 630.

In the example of FIG. 6, a machine learning model (such as the machine learning model described with reference to FIGS. 2-3) decomposes user interaction data 605 into first set of steps 610, second set of steps 615, third set of steps 620, fourth set of steps 625, and residual set of steps 630 by applying various window sizes to user interaction data 605. As shown in FIG. 6, as a window size decreases, the set of steps becomes increasingly fine and includes more data points.

FIG. 7 shows an example of an illustration of hierarchical prediction according to aspects of the present disclosure. The example shown includes first set of steps 705, first intermediate prediction 710, second set of steps 715, second intermediate prediction 720, third set of steps 725, third intermediate prediction 730, fourth set of steps 735, fourth intermediate prediction 740, residual set of steps 745, and residual prediction 750. As shown in FIG. 7, the intermediate predictions are separated from the sets of steps by a dotted line.

In the example of FIG. 7, a machine learning model (such as the machine learning model described with reference to FIGS. 2-3) generates, using respective layers of the machine learning model, first intermediate prediction 710 based on first step of steps 705, second intermediate prediction 720 based on first intermediate prediction 710 and second set of steps 715, third intermediate prediction 730 based on first intermediate prediction 710, second intermediate prediction 720, and third set of steps 725, fourth intermediate prediction 740 based on first intermediate prediction 710, second intermediate prediction 720, third intermediate prediction 730, and fourth set of steps 735, and residual prediction 750 based on first intermediate prediction 710, second intermediate prediction 720, third intermediate prediction 730, fourth intermediate prediction 740, and residual set of steps 745.

As shown in FIG. 7, the machine learning model computes a mean line parameter m₋ᵢ and a slope line parameter d₋ᵢ for each of first set of steps 705, second set of steps 715, third set of steps 725, and fourth set of steps 735, and computes a predicted mean line parameter m₊ⱼ and a slope line parameter d₊ⱼ based on each of first set of steps 705, second set of steps 715, third set of steps 725, and fourth set of steps 735. As shown in FIG. 7, the window sizes correspond to the window sizes of FIG. 6.

### Training

A method for training a machine learning model is described with reference to FIGS. 8-10. One or more aspects of the method include creating a first training set by applying a first window size to a time series; training a first layer of a machine learning model using the first training set; creating a second training set by applying a second window size to the time series, wherein the second window size is less than the first window size; and training a second layer of the machine learning model using the second training set. In some aspects, the second layer is trained based on an output of the first layer.

Some examples of the method further include dividing the time series into a plurality of first steps having the first window size, wherein the first layer of the machine learning model is trained to predict one or more line parameters for each of the plurality of first steps. Some examples of the method further include dividing the time series into a plurality of second steps having the second window size, wherein the second layer of the machine learning model is trained to predict the one or more line parameters for each of the plurality of second steps.

In some aspects, training the first layer of the machine learning model comprises computing a first line parameter for a first portion of the time series corresponding to the first window size, computing, using the first layer of the machine learning model, a first predicted line parameter for the first portion of the time series, and computing a first loss function based on the first line parameter and the first predicted line parameter. In some aspects, the first line parameter comprises a scalar value or a slope value.

In some aspects, training the second layer of the machine learning model comprises computing a second line parameter for a second portion of the time series corresponding to the second window size, computing, using the second layer of the machine learning model, a second predicted line parameter for the second portion of the time series, and computing a second loss function based on the second line parameter, the second predicted line parameter, and the first predicted line parameter.

Some examples of the method further include creating a third training set by applying a third window size to the time series, wherein the third window size is less than the second window size. Some examples further include training a third layer of the machine learning model using the third training set. Some examples of the method further include training a residual layer of the machine learning model based on an output of the first layer, an output of the second layer, and the time series.

FIG. 8 shows an example of a method 800 for training a machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 8, according to some aspects, a machine learning model is trained for predicting making predictions based on a hierarchical decomposition of time series data. According to some aspects, the machine learning model creates a first training set by applying a first window size to a time series, and first layer of the machine learning model is trained using the first training set. According to some aspects, the machine learning model creates a second training set by applying a second window size to the time series, and a second layer of the machine learning model is trained using the second training set. In some cases, the second window size is less than the first window size.

Accordingly, in some cases, by respectively training successive layers of the machine learning model based on created training sets of successively decreasing granularity (e.g., of a successively increasing number of samples within the training sets), the machine learning model learns from a time series in a hierarchical manner, and is therefore able to provide an accurate prediction based on the time series that is more robust against a potential shift in data distribution in the time series than conventional time series forecasting models.

At operation 805, the system creates a first training set by applying a first window size to a time series. In some cases, the operations of this step refer to, or are performed by, a machine learning model as described with reference to FIGS. 2 and 3.

For example, in some cases, the machine learning model retrieves the time series from a database (such as the database described with reference to FIG. 1), or from another data source (such as the Internet). In some cases, the data processing apparatus provides the time series to the machine learning model. In some cases, the machine learning model divides the time series into a set of first steps having the first window size. In some cases, the first window size is predefined. In some cases, the first window size is predefined based on a periodicity of the time series. In some cases, given the time series X=[x₀, x₁, . . . , x_{T-1}] of T steps, a window τ=T/L, where the time series X is split into L segments [X₀, X₁, . . . , X_{L-1}] where Xᵢ=[x_{i+τ}, x_{i+τ+1}, . . . , x_{(i+1)*τ-1}].

At operation 810, the system trains a first layer of a machine learning model using the first training set. In some cases, the operations of this step refer to, or are performed by, a training component as described with reference to FIG. 2.

For example, in some cases, the machine learning model computes a first line parameter for a first portion of the time series corresponding to the first window size. In some cases, the first line parameter comprises a scalar value (such as a mean m) or a slope value (such as a slope d). In some cases, a first layer of the machine learning model (such as the machine learning model described with reference to FIGS. 2-3) computes a first predicted line parameter for the first portion of the time series.

According to some aspects, mini-batch sampling is performed. For example, in some cases, for each segment Xᵢ, least squares regression is used to fit a layer of the machine learning model (such as the first layer) parameterized by a mean value mᵢ and a slope dᵢ=kᵢτ, where kᵢ=(Ψ^{T}Xᵢ)/(Ψ^{T}Ψ), and temporal index Ψ=[−(τ−1)/2, −(τ−1)/2+1, . . . , (τ−1)/2−1, (τ−1)/2], providing a piece-wise linear fitting of time series X, denoted as {(mᵢ, dᵢ)}. In some cases, the linear fitting is finished during a data loader processing stage.

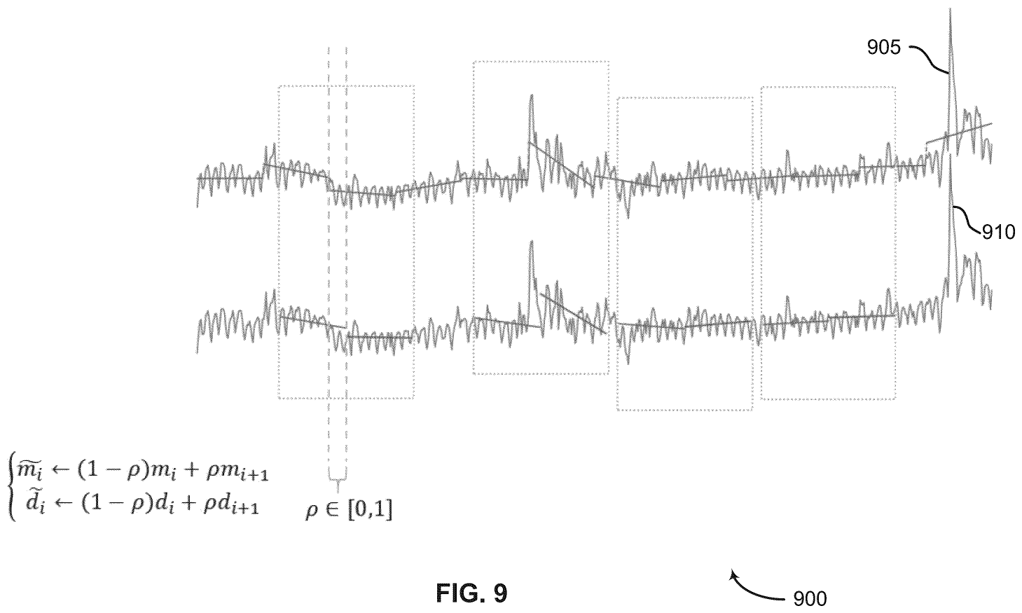

In some cases, during training, the training component samples a training sequence as C=[X_{t-|C|}, x_{t-|C|+1}, . . . , xₜ₋₁] and Y=[xₜ, xₜ₊₁, . . . , x_{t+|Y|+1}], where C is a context, |C| is a context length, Y is a prediction, |Y| is a prediction length, and t is a randomly sampled index. In some cases, a last context segment corresponds to \hat{X}ₜ=[x_{t-τ}, x_{t-τ+1}, . . . , xₜ₋₁]. In some cases, \hat{X}ₜ belongs to a precomputed set, and the precomputed parameters are directly fetched. In some cases, \hat{X}ₜ overlaps with two segments (e.g., \hat{X}ᵢ and Xᵢ₊₁), and a weighted interpolation between (mᵢ, dᵢ) and (mᵢ₊₁, dᵢ₊₁) approximates parameters of X̅ₜ. A process of mini-batch sampling is described with reference to FIG. 9.

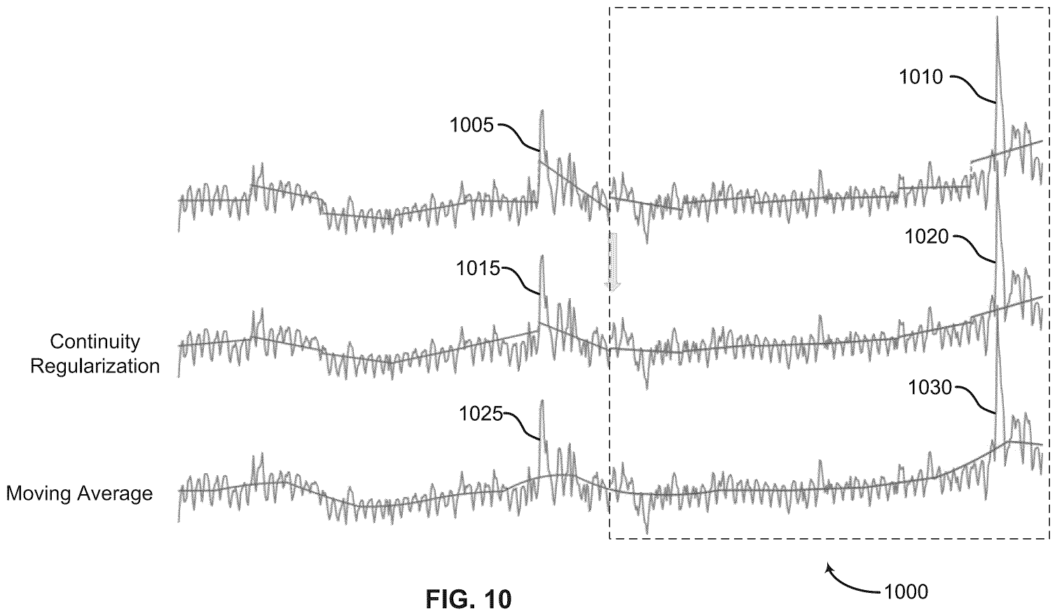

In some cases, multiple segments are used to construct the sequence, which potentially leads to discontinuity at border time steps. In some cases, the discontinuity is alleviated by performing one or more of substituting {(mᵢ, dᵢ)} from the least squares regression with a solution of an optimization problem, realized by \hat{m}ᵢ=mᵢ+αᵢ, \hat{d}ᵢ=dᵢ+ρᵢ, where αᵢ and βᵢ are small displacements, and applying a moving average on an expanded sequence from {(mᵢ, dᵢ)}. A process of alleviating a discontinuity is described with reference to FIG. 10.

According to some aspects, the training component computes a first loss function based on the first line parameter and the first predicted line parameter. A loss function refers to a function that impacts how a machine learning model is trained in a supervised learning model. For example, during each training iteration, the output of the machine learning model is compared to the known annotation information in the training data. The loss function provides a value (the “loss”) for how close the predicted annotation data is to the actual annotation data. After computing the loss, the parameters of the model are updated accordingly and a new set of predictions are made during the next iteration.

Supervised learning is a machine learning technique based on learning a function that maps an input to an output based on example input-output pairs. Supervised learning generates a function for predicting labeled data based on labeled training data consisting of a set of training examples. In some cases, each example is a pair consisting of an input object (typically a vector) and a desired output value (i.e., a single value, or an output vector). In some cases, a supervised learning algorithm analyzes the training data and produces the inferred function, which is used for mapping new examples. In some cases, the learning results in a function that correctly determines the class labels for unseen instances. In other words, the learning algorithm generalizes from the training data to unseen examples. In some cases, the training component updates image generation parameters of image generation model 2015 based on the loss.

According to some aspects, layers of the machine learning model are trained from coarse to fine sequentially, where “coarse” indicates a larger window size and a smaller number of steps in a set of steps included in a coarse window, and “fine” indicates a smaller window size and a larger number of steps in a set of steps included in a fine window. In some cases, given W layers of the machine learning model (for example, including one or more of a first layer, a second layer, a third layer, a residual layer, etc.), a training process of the machine learning model is divided into W even parts. In some cases, at a w-th substage of the training process, only w first layers (e.g., trend models) are trained.

According to some aspects, C^{k} denotes a context at a k-th level of the machine learning model, f^{k}(⋅) denotes a mapping of a k-th level parameterized by Wₘ^{k}, W_{d}^{k} that outputs an expanded piece-wise linear prediction, and a loss function at the w-th substage is:

$${ℒ}^{w} = {\sum }_{s = 0}^{w - 1} \frac{1}{s + 1} ℓ ( {\sum }_{k = 0}^{s} {f}^{k} ( {C}^{k} ) , Y ) + ℓ ( \{ ( {m}_{+}^{s} , {d}_{+}^{s} ) \} ) \qquad ( 1 )$$

According to some aspects, as the decomposition of the time series proceeds from coarse to fine, the sum of any first k-level trend predictions are expected to be close to ground-truth values, which is reflected in the enumeration over s in equation 1. Referring to equation 1, the first term is a values fitting loss, in which 1/(s+1) is a weighting coefficient to put more emphasis on coarser predictions, and the second term is a parameters fitting loss that measures the mean-squared-error between the prediction of the machine learning model (e.g., the predicted line parameters) and the line parameters of the time series (e.g., the ground-truth values). According to some aspects, the training component updates parameters of the first layer of the machine learning model according to the loss determined by equation 1.

At operation 815, the system creates a second training set by applying a second window size to the time series, where the second window size is less than the first window size. In some cases, the operations of this step refer to, or are performed by, a machine learning model as described with reference to FIGS. 2 and 3. For example, in some cases, the machine learning model divides the time series into a set of second steps having the second window size. In some cases, the second training set is accordingly “finer” than the first training set, as the window size of the second training set is smaller than the window size of the first training set, and the second training set therefore includes more time steps than the first training set.

At operation 820, the system trains a second layer of the machine learning model using the second training set. In some cases, the operations of this step refer to, or are performed by, a training component as described with reference to FIG. 2. For example, in some cases, the machine learning model computes a second line parameter for a second portion of the time series corresponding to the second window size, a second layer of the machine learning model computes a second predicted line parameter for the second portion of the time series, and the training component computes a second loss function (for example, using equation 1) based on the second line parameter, the second predicted line parameter, and the first predicted line parameter. According to some aspects, the training component updates parameters of the second layer of the machine learning model according to the second loss function.

Accordingly, because the second layer is trained based on an output of the first layer, and the first layer and the second layer correspond to sets of steps having different window sizes, the machine learning model is trained in a hierarchical manner, which allows the machine learning model to learn to make more accurate predictions than conventional machine learning models.

According to some aspects, the machine learning model creates a third training set (and, in some cases, a fourth training set, a fifth training set, etc.) by applying a third window size (and, in some cases, a fourth window size, a fifth window size, etc.) to the time series, wherein the third window size (and each successive window size) is less than the second window size (and each preceding window size).

According to some aspects, the machine learning model computes a line parameter of a third portion of the time series (and, in some cases, the fourth training set, the fifth training set, etc.) corresponding to the third window size (and, in some cases, the fourth window size, the fifth window size, etc.) as described above with respect to the first portion set and the second portion set. According to some aspects, a third layer of the machine learning model (and, in some cases, a fourth layer, a fifth layer, etc.) computes a third predicted line parameter for the third portion of the time series (and, in some cases, a fourth predicted line parameter for the fourth portion, etc.) as described above with respect to the first layer and the second layer. According to some aspects, the training component updates the parameters of the third layer (and, in some cases, the fourth layer, the fifth layer, etc.) according to a loss function determined by equation 1.

According to some aspects, the machine learning model creates a residual training set of the time series. In some cases, the machine learning model computes a residual line parameter (e.g., an average) for a residual portion of the time series corresponding to the residual of the time series. In some cases, a residual layer of the machine learning model computes a predicted line parameter for the residual portion of the time series. In some cases, each layer of the machine learning model, including the residual layer, is trained according to a residual loss function:

$$ℒ = ℓ ( {\sum }_{s = 0}^{W - 1} {f}^{s} ( {C}^{s} ) + S ( R ) , Y ) \qquad ( 2 )$$

Referring to equation 2, S(⋅) is the residual (e.g., seasonality) layer and R is the residual (e.g., seasonal) portion of the training set.

FIG. 9 shows an example 900 of mini-batch sampling according to aspects of the present disclosure. The example shown includes time series with line parameters 905 and time series with approximated line parameters 910.

Referring to FIG. 9, in some cases, a machine learning model (such as the machine learning mode described with reference to FIGS. 2-3) performs a simple weighted interpolation between (mᵢ, dᵢ) and (mᵢ₊₁, dᵢ₊₁) to approximate parameters of X̅ₜ, where:

$$\{ \begin{matrix}{\tilde{m}}_{i} ← ( 1 - ρ ) {m}_{i} + ρ {m}_{i + 1} \\ {\tilde{d}}_{i} ← ( 1 - ρ ) {d}_{i} + ρ {d}_{i + 1}\end{matrix} , ρ ∈ [ 0 , 1 ] \qquad ( 3 )$$

FIG. 10 shows an example 1000 of applying continuity regularization and moving average techniques according to aspects of the present disclosure. The example shown includes decomposed context 1005, prediction 1010, context with continuity regularization 1015, prediction with continuity regularization 1020, context with moving average 1025, and prediction with moving average 1030. As shown in FIG. 10, prediction 1010, prediction with continuity regularization 1020, and prediction with moving average 1030 are separated from decomposed context 1005, context with continuity regularization 1015, and context with moving average 1025 by a dotted line.

Referring to FIG. 10, according to some aspects, a use of multiple windows to construct a sequence causes discontinuities at border time steps in some cases, in both a decomposition of a context and a creation of a prediction. As described with reference to FIG. 9, one or more of a continuity regularization technique and a moving average technique are used in some cases to resolve the discontinuities.

The description and drawings described herein represent example configurations and do not represent all the implementations within the scope of the claims. For example, in some cases, the operations and steps are rearrangeable, combinable, or otherwise modifiable. Also, in some cases, structures and devices are represented in the form of block diagrams to represent the relationship between components and avoid obscuring the described concepts. In some cases, similar components or features have the same name but have different reference numbers corresponding to different figures.

Some modifications to the disclosure will be readily apparent to those skilled in the art, and the principles defined herein are applicable to other variations without departing from the scope of the disclosure. Thus, the disclosure is not limited to the examples and designs described herein, but is to be accorded the broadest scope consistent with the principles and novel features disclosed herein.

In some cases, the described methods are implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. In some cases, a general-purpose processor is a microprocessor, a conventional processor, controller, microcontroller, or state machine. In some cases, a processor is implemented as a combination of computing devices (e.g., a combination of a DSP and a microprocessor, multiple microprocessors, one or more microprocessors in conjunction with a DSP core, or any other such configuration). Thus, in some cases, the functions described herein are implemented in hardware or software and are executed by a processor, firmware, or any combination thereof. If implemented in software executed by a processor, the functions are in some cases stored in the form of instructions or code on a computer-readable medium.

Computer-readable media includes both non-transitory computer storage media and communication media including any medium that facilitates transfer of code or data. In some cases, a non-transitory storage medium is any available medium that is accessible by a computer. For example, in some cases, non-transitory computer-readable media comprises random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, in some cases, connecting components are properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” is also based on a condition B in some cases. In other words, the phrase “based on” shall be construed to mean “based at least in part on.” Also, the words “a” or “an” indicate “at least one.”

What is claimed is:

1. A method of training a machine learning model, comprising:
creating, using the machine learning model, a first training set by applying a first window size to a time series;
training, using a training component, a first layer of the machine learning model using the first training set;
creating, using the machine learning model, a second training set by applying a second window size to the time series, wherein the second window size is less than the first window size; and
training, using the training component, a second layer of the machine learning model using the second training set.

2. The method of claim 1, further comprising:
dividing, using the machine learning model, the time series into a plurality of first steps having the first window size, wherein the first layer of the machine learning model is trained to predict one or more line parameters for each of the plurality of first steps.

3. The method of claim 2, further comprising:
dividing, using the using the machine learning model, the time series into a plurality of second steps having the second window size, wherein the second layer of the machine learning model is trained to predict the one or more line parameters for each of the plurality of second steps.

4. The method of claim 1, wherein training the first layer of the machine learning model comprises:
computing, using the machine learning model, a first line parameter for a first portion of the time series corresponding to the first window size;
computing, using the first layer of the machine learning model, a first predicted line parameter for the first portion of the time series; and
computing, using the training component, a first loss function based on the first line parameter and the first predicted line parameter.

5. The method of claim 4, wherein training the second layer of the machine learning model comprises:
computing, using the machine learning model, a second line parameter for a second portion of the time series corresponding to the second window size;
computing, using the second layer of the machine learning model, a second predicted line parameter for the second portion of the time series; and
computing, using the training component, a second loss function based on the second line parameter, the second predicted line parameter, and the first predicted line parameter.

6. The method of claim 4, wherein:
the first line parameter comprises a scalar value or a slope value.

7. The method of claim 1, further comprising:
creating, using the machine learning model, a third training set by applying a third window size to the time series, wherein the third window size is less than the second window size; and
training, using the training component, a third layer of the machine learning model using the third training set.

8. The method of claim 7, further comprising:
training, using the training component, a residual layer of the machine learning model based on an output of the first layer, an output of the second layer, and the time series.

9. The method of claim 1, wherein:
the second layer is trained based on an output of the first layer.

10. A method for providing digital content, comprising:
obtaining, using a machine learning model, user interaction data;
decomposing, using the machine learning model, the user interaction data into a first set of steps based on a first window size and a second set of steps based on a second window size, wherein the second window size is less than the first window size;
generating, using the machine learning model, predicted user interaction data based on the user interaction data by generating a first intermediate output using a first layer of the machine learning model based on the first set of steps and generating a second intermediate output using a second layer of the machine learning model based on the second set of steps and the first intermediate output; and
providing, via a user interface, digital content to a user based on the predicted user interaction data.

11. The method of claim 10, wherein obtaining the user interaction data comprises:
monitoring, using a data monitoring component, user engagement with a website.

12. The method of claim 10, wherein providing the digital content comprises:
generating, using a digital content component, the digital content based on the predicted user interaction data; and
displaying, via the user interface, the digital content on a website.

13. The method of claim 10, wherein generating the predicted user interaction data comprises:
generating, using a third layer of the machine learning model, a third intermediate output based on a third set of steps, the first intermediate output, and the second intermediate output, wherein the third set of steps is based on a third window size.

14. The method of claim 10, wherein generating the predicted user interaction data comprises:
generating, using a residual layer of the machine learning model, a residual output based on the user interaction data, the first intermediate output, and the second intermediate output.

15. The method of claim 10, wherein:
the first intermediate output and the second intermediate output comprise line parameters for linearized portions of the user interaction data.

16. The method of claim 10, wherein:
the machine learning model is trained based on a hierarchical decomposition of a training time series.

17. An apparatus for time series data prediction, comprising:
at least one processor;
at least one memory storing instructions executable by the at least one processor; and
a machine learning model comprising machine learning parameters stored in the at least one memory, the machine learning model trained to predict time series data, the machine learning model comprising a first layer trained using a first training set created by applying a first window size to a time series and a second layer trained using a second training set created by applying a second window size to the time series, wherein the second window size is less than the first window size.

18. The apparatus of claim 17, wherein:
the machine learning model further comprises a third layer trained using a third training set created by applying a third window size to the time series, wherein the third window size is less than the second window size.

19. The apparatus of claim 17, wherein:
the machine learning model further comprises a residual layer trained based on an output of the first layer, an output of the second layer, and the time series.

20. The apparatus of claim 17, further comprising:
a user interface configured to provide content to a user based on an output of the machine learning model.
